(19) United States
(12) Patent Application Publication
(10) Pub. No.: US 2026/0321690 A1
(43) Pub. Date: Oct. 15, 2026

(54) FUEL CELL SYSTEM AND METHOD FOR OPERATING A FUEL CELL SYSTEM

(71) Applicant: Robert Bosch GmbH, Stuttgart (DE)

(72) Inventors: Jonas Breitinger, Stuttgart (DE); Mark Hellmann, Korntal (DE)

(21) Appl. No.: 19/166,112

(22) PCT Filed: Feb. 8, 2024
(86) PCT No.: PCT/EP2024/053165

§ 371 Date: Sep. 17, 2025

(30) Foreign Application Priority Data
Mar. 30, 2023 (DE) 10 2023 202 925.1

(51) Int. Cl. H01M 8/04746; H01M 8/04298; H01M 8/0438; H01M 8/0444

(52) U.S. Cl. CPC H01M 8/04761; H01M 8/04305; H01M 8/04388; H01M 8/04455; H01M 8/04462; H01M 8/04753

(57) ABSTRACT

The invention presented relates to a fuel cell system (100) for converting energy, wherein the fuel cell system (100) comprises:
a fuel cell stack (101),
an anode tract (103) for supplying the fuel cell stack (101) with fuel,
a discharge valve (105) for discharging anode gas out of the anode tract (103),
a metering valve (107) for metering fuel into the anode tract (103),
a computing unit (109),
   wherein the computing unit (109) is configured to actuate the metering valve (107) in a clocked manner, and
   wherein the computing unit (109) is additionally configured to
   actuate the discharge valve (105) in a clocked manner on the basis of the actuation of the metering valve (107).

### BACKGROUND

The invention presented relates to a fuel cell system and a method for operating a fuel cell system according to the disclosure.

Hydrogen-based fuel cell systems are regarded as the mobility concept of the future, as they only emit water as exhaust gas, and enable fast refueling times.

It is known in the operation of a fuel cell system that anode gas is recirculated in order to minimize hydrogen losses and to maximize inlet humidity.

For the recirculation, either a so-called “jet pump”, a recirculation blower or a combination of both concepts may be used.

In the operation of a fuel cell system, water and nitrogen accumulate in the anode circuit, gradually displacing the hydrogen. In order to avoid an excessively low hydrogen concentration and to reduce the energy required for recirculation, the anode circuit is therefore regularly flushed with fresh hydrogen in a so-called “purge”. For this purpose, the discharge valve or a so-called “purge valve” is opened briefly and part of the gas mixture is directed into the cathode exhaust path.

From a cost and installation space perspective, it is advantageous to use only one jet pump.

For the proper operation of the jet pump, a minimum primary mass flow is required, below which a subcritical flow and the collapse of a recirculation mass flow occur.

A known approach to extending the operating range of a fuel cell system is the clocked actuation of a metering valve or a so-called “hydrogen gas injector (HGI)” in order to operate the jet pump in phases above the minimum mass flow rate and at the same time not to supply significantly more hydrogen than is consumed in the fuel cell stack on average over time.

Independent of the interaction between the metering valve and the jet pump, clocked actuation of the metering valve is known in many fuel cell systems.

### SUMMARY

In the context of the invention presented, a fuel cell system and a method for operating the fuel cell system are presented. Further features and details of the invention may be derived from the respective subordinate claims, the description, and the drawings. Features and details described in connection with the method according to the invention naturally also apply in connection with the fuel cell system according to the invention, and vice versa, respectively, such that reference is or may be made mutually with respect to the disclosure of the individual aspects of the invention.

The invention presented serves, in particular, to provide a fuel-efficient fuel cell system.

Therefore, according to a first aspect of the present invention, a fuel cell system for converting energy is presented.

The fuel cell system presented comprises a fuel cell stack, an anode tract for supplying the fuel cell stack with fuel, a discharge valve for discharging anode gas out of the anode tract, a metering valve for metering fuel into the anode tract, and a computing unit, wherein the computing unit is configured to actuate the metering valve in a clocked manner, and wherein the computing unit is further configured to actuate the discharge valve in a clocked manner on the basis of an actuation of the metering valve.

In the context of the invention presented here, a computing unit is to be understood as a computer, a control unit, a processor or any other programmable circuit.

In the context of the invention presented, a metering valve is to be understood as a valve for metering fuel into an anode tract, such as a proportional valve.

In the context of the invention presented, a discharge valve is to be understood as a valve for discharging anode gas out of an anode tract, such as a so-called “purge valve”.

In the context of the invention presented, clocked actuation is to be understood as the operation of a valve in which the valve is opened and closed at regular intervals, for example, with a predefined frequency ranging from 0.1 Hz to 50 Hz.

The invention presented is based on the principle that both the metering valve and the discharge valve of the fuel cell system presented are actuated in a clocked manner, such that fuel losses are minimized and the fuel efficiency of the fuel cell system is maximized. As a result, the fuel concentration in the exhaust gas of the fuel cell system is minimized, and operational safety of the fuel cell system is maximized.

Furthermore, very dry conditions in the anode tract may be avoided by minimizing water vapor losses, which maximizes membrane conductivity and, as a result, the service life of the fuel cell system. Accordingly, the invention presented enables an increase in service life by avoiding dry conditions and a gain in efficiency due to high membrane conductivity.

Through an actuation of the discharge valve on the basis of an actuation of the metering valve, a nitrogen phase, i.e., a quantity of anode gas that contains relatively less fuel than another quantity of anode gas, may be discharged, for example, by actuating the discharge valve before the quantity of fuel metered into the anode tract via the metering valve reaches the discharge valve.

Alternatively, a relative humidity in the anode tract may be maximized through an actuation of the discharge valve on the basis of an actuation of the metering valve, for example, by discharging a fuel phase, i.e., a quantity of anode gas that contains relatively more fuel than another quantity of anode gas.

By determining the time that has elapsed since the metering valve was activated, the gas composition present at the discharge valve may be inferred and the discharge valve may be actuated accordingly.

It may be provided that the computing unit is configured to actuate the discharge valve within a time interval that lies between a first time at which the metering valve is actuated to meter fuel into the anode tract at an anode inlet, and a second time at which the fuel concentration at an anode outlet increases in response to the metering of fuel via the metering valve.

Activation of the discharge valve between a first time at which the metering valve is actuated to meter fuel into the anode tract at an anode inlet and a second time at which a fuel concentration at an anode outlet increases in response to the metering of fuel by the metering valve results in minimal discharge of fuel by actuating the vent valve by utilizing a gas transit time of the fuel in the anode tract to activate the vent valve and to vent the anode gas from the anode tract for a purging process, which anode gas migrates through the anode tract before a gas phase metered in by the metering valve.

It may further be provided that the computing unit is configured to determine the second time on the basis of a gas transit time between the anode inlet and the anode outlet in order to minimize fuel losses by actuating the discharge valve.

As the gas transit time may vary depending on the operating point, the second time may be determined dynamically via the gas transit time.

It may be provided that the computing unit is configured to determine the second time by means of a length of a distance between the metering valve and the discharge valve, and a flow rate of fuel flowing in the anode tract, and to determine the flow rate by means of a mathematical model of the fuel cell system for a current operating point of the fuel cell system.

A mathematical model of the fuel cell system presented, in which, for example, temperatures and pressures are mathematically mapped depending on the operating point, enables a particularly precise determination of the gas transit time and, as a result, the second time at which the discharge valve is deactivated, for example.

It may further be provided that the computing unit is configured to determine the second time on the basis of measured values ascertained by a lambda sensor at the anode outlet and/or measured values ascertained by a hydrogen concentration sensor in a cathode tract of the fuel cell system.

Since a lambda sensor quantifies a mass flow at the anode outlet, the measured values of the lambda sensor may be used to directly infer a gas transit time through the anode tract.

Since a hydrogen concentration sensor in a cathode tract of the fuel cell system determines a composition of a gas discharged through the discharge valve, measured values from the hydrogen concentration sensor may be used, for example, to set an opening time of the discharge valve in order to discharge more or less fuel.

It may also be provided that the computing unit comprises a memory in which a mapping scheme is stored that assigns an activation time for activating the discharge valve to a current operating point of the fuel cell system, and that the computing unit is configured to actuate the discharge valve at a time assigned to the current operating point of the fuel cell system.

A mapping scheme stored in a memory may minimize the computing load on the computing unit of the fuel cell system presented.

It may also be provided that the computing unit is configured to actuate the metering valve in such a way that a time interval for which the discharge valve is activated overlaps a time interval for which the metering valve is activated.

By superimposed actuation of the metering valve and the discharge valve, a very short gas transit time or a very small nitrogen phase may be covered.

It may further be provided that the computing unit is configured to actuate the discharge valve within a time interval that begins when a fuel concentration at an anode outlet decreases again after having increased in response to an actuation of the metering valve, in order to minimize water vapor losses through actuation of the discharge valve.

Through an actuation of the discharge valve within a time interval that begins when a fuel concentration at an anode outlet decreases again after having increased in response to an actuation of the metering valve, a dry fuel phase metered in by the metering valve is discharged for a purging process and, as a result, a humid nitrogen phase in the anode tract is maximized.

It may also be provided that a time period for which the metering valve is to be actuated differs from a time period for which the discharge valve is to be actuated.

For example, more gas may be discharged from the anode tract than is metered into the anode tract or less gas may be discharged than is metered in, e.g., in order to discharge only a nitrogen phase flowing before a metered-in fuel phase.

It is also possible that the computing unit is configured to actuate the discharge valve only when it is necessary to discharge anode gas for operational reasons.

In order to avoid an unnecessary discharge of fuel, the discharge valve may only be actuated when it is required for operation of the fuel cell system, but then on the basis of an actuation of the metering valve.

According to a second aspect, the invention presented relates to a method for operating a fuel cell system, in which a discharge valve of a possible embodiment of the fuel cell system presented is actuated in a clocked manner on the basis of an actuation of a metering valve of the fuel cell system.

Further advantages, features, and details of the invention arise from the following description, in which exemplary embodiments of the invention are described in detail with reference to the drawings. In this context, the features mentioned in the disclosure and in the description may each be essential to the invention individually or in any combination.

### BRIEF DESCRIPTION OF THE DRAWINGS

It shows:

FIG. 1 a schematic representation of one possible embodiment of the fuel cell system presented,

FIG. 2 a possible embodiment of the method presented,

FIG. 3 a further possible embodiment of the method presented.

### DETAILED DESCRIPTION

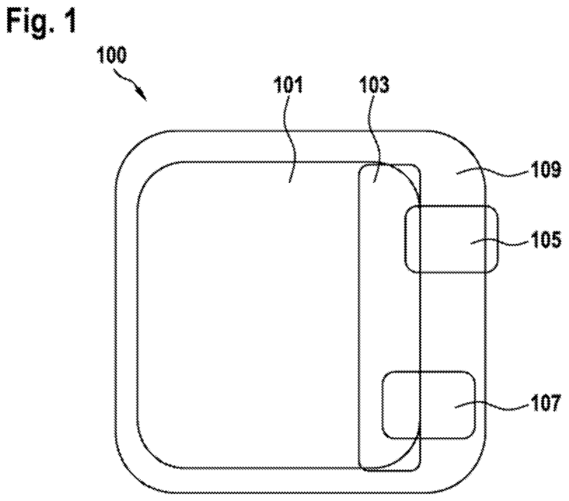

FIG. 1 shows a fuel cell system 100. The fuel cell system 100 comprises a fuel cell stack 101, an anode tract 103 for supplying the fuel cell stack 100 with fuel, a discharge valve 105 for discharging anode gas out of the anode tract 103, a metering valve 107 for metering fuel into the anode tract 103, and a computing unit 109.

The computing unit 109 is configured to actuate the metering valve 107 in a clocked manner, for example, at a predetermined frequency, and to actuate the discharge valve 105 in a clocked manner, for example, at the predetermined frequency, on the basis of an actuation of the metering valve 107.

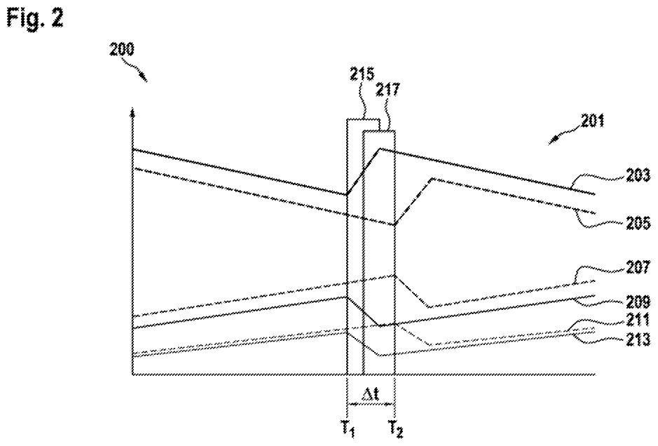

FIG. 2 shows an operating method 200. In a diagram 201, the time is plotted on the abscissa and a molar fraction in an anode gas is plotted on the ordinate.

A first curve 203 represents a molar fraction of fuel measured at an anode inlet.

A second curve 205 represents a molar fraction of fuel measured at an anode outlet.

A third curve 207 represents a molar fraction of water measured at an anode inlet.

A fourth curve 209 represents a molar fraction of water measured at an anode outlet.

A fifth curve 211 represents a molar fraction of nitrogen measured at an anode inlet.

A sixth curve 213 represents a molar fraction of nitrogen measured at an anode outlet.

A bar 215 represents an actuation period for actuating the metering valve 109.

A bar 217 represents an actuation period for actuating the discharge valve 107.

A distance At represents a distance between a first time T₁, at which the metering valve 107 is actuated to meter fuel into the anode tract at an anode inlet, and a second time T₂, at which a fuel concentration at an anode outlet increases in response to the metering of fuel by the metering valve 107.

A comparison of the bar 215 with the bar 217 shows that the actuation period for actuating the discharge valve 105 extends up to the second time T₂ in order to minimize the discharge of fuel-containing gas. Through a deactivation of the discharge valve 105 at an inflection point of the curve 205, a discharge of gas with a high fuel content is avoided or merely “purged” until fuel metered in by the metering valve 105 has reached the discharge valve 107.

Accordingly, activation of the discharge valve 107 in the time interval of the bar 217 maximizes the discharge of water and nitrogen.

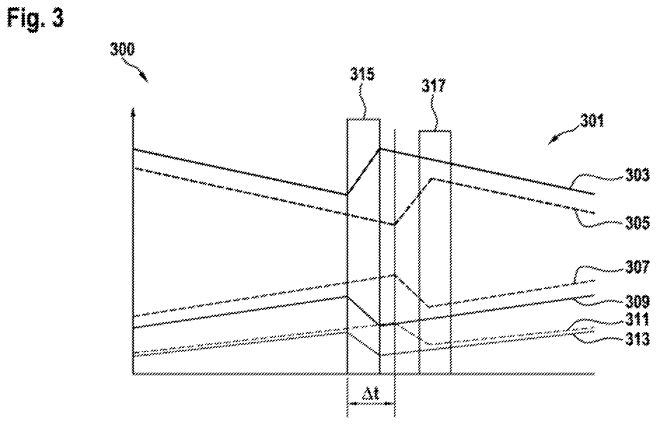

FIG. 3 shows an operating method 300. In a diagram 301, the time is plotted on the abscissa and the molar fraction in an anode gas is plotted on the ordinate.

A first curve 303 represents a molar fraction of fuel measured at an anode inlet.

A second curve 305 represents a molar fraction of fuel measured at an anode outlet.

A third curve 307 represents a molar fraction of water measured at an anode inlet.

A fourth curve 309 represents a molar fraction of water measured at an anode outlet.

A fifth curve 311 represents a molar fraction of nitrogen measured at an anode inlet.

A sixth curve 313 represents a molar fraction of nitrogen measured at an anode outlet.

A bar 315 represents an actuation period for actuating the metering valve 109.

A bar 317 represents an actuation period for actuating the discharge valve 105.

Through an activation of the discharge valve 105 within a time interval that begins after the metering valve 107 has been actuated and the curve 305 flattens out again after an increase at its inflection point, the discharge of water and nitrogen from the anode tract is minimized and the membrane humidity of the fuel cell system is maximized.

1. A fuel cell system (100) for converting energy, wherein the fuel cell system (100) comprises:
a fuel cell stack (101),
an anode tract (103) for supplying the fuel cell stack (101) with fuel,
a discharge valve (105) for discharging anode gas out of the anode tract (103),
a metering valve (107) for metering fuel into the anode tract (103),
a computing unit (109),
wherein the computing unit (109) is configured to actuate the metering valve (107) in a clocked manner, and
wherein the computing unit (109) is additionally configured to
actuate the discharge valve (105) in a clocked manner based on the actuation of the metering valve (107).

2. The fuel cell system (100) according to claim 1, wherein
the computing unit (109) is configured to actuate the discharge valve (105) within a time interval which lies between a first time at which the metering valve (107) is actuated in order to meter fuel into the anode tract (103) at an anode inlet, and a second time at which a fuel concentration at an anode outlet rises in response to the metering of fuel by the metering valve (107).

3. The fuel cell system (100) according to claim 2, wherein
the computing unit (109) is configured to determine the second time based on a gas transit time between the anode inlet and the anode outlet in order to minimize fuel losses by actuating the discharge valve (105).

4. The fuel cell system (100) according to claim 2,
wherein
the computing unit (109) is configured to determine the second time by means of a length of a distance between the metering valve (107) and the discharge valve (105), and a flow rate of fuel flowing in the anode tract (103), and to determine the flow rate by means of a mathematical model of the fuel cell system (100) for a current operating point of the fuel cell system (100).

5. The fuel cell system (100) according to claim 2, wherein
the computing unit (109) is configured to determine the second time based on measured values ascertained by a lambda sensor at the anode outlet and/or measured values ascertained by a hydrogen concentration sensor in a cathode tract of the fuel cell system (100).

6. The fuel cell system (100) according to claim 1,
wherein
the computing unit (109) comprises a memory in which a mapping scheme is stored which assigns an activation time for activating the discharge valve (105) to a current operating point of the fuel cell system (100), and
the computing unit (109) is configured to actuate the discharge valve (105) at a time associated with the current operating point of the fuel cell system (100).

7. The fuel cell system (100) according to claim 1,
wherein
the computing unit (109) is configured to actuate the metering valve (107) in such a way that a time interval for which the discharge valve (105) is activated overlaps a time interval for which the metering valve (107) is activated.

8. The fuel cell system (100) according to claim 1,
wherein
the computing unit (109) is configured to actuate the discharge valve (105) within a time interval which begins when a fuel concentration at an anode outlet decreases again after having increased in response to an actuation of the metering valve (107), in order to minimize water vapor losses through actuation of the discharge valve (105).

9. The fuel cell system (100) according to claim 1,
wherein
a time period for which the metering valve (107) is to be actuated differs from
a time period for which the discharge valve (105) is to be actuated.

10. The fuel cell system (100) according to claim 1,
wherein
the computing unit (109) is configured to actuate the discharge valve (105) only when it is necessary to discharge anode gas for operational reasons.

11. An operating method (200, 300) for a fuel cell system (100),
in which a discharge valve (105) of a fuel cell system (100) according to claim 1 is actuated in a clocked manner based on an actuation of a metering valve (107) of the fuel cell system (100).
